(19) United States
(12) Patent Application Publication
(10) Pub. No.: US 2004/0069808 A1
(43) Pub. Date: Apr. 15, 2004

(54) Storage and dispensing system

(76) Inventor: Robert J. Blain, Middleville, MI (US)

Correspondence Address: Woodard, Emhardt, Naughton,, Moriarty and McNett, Bank One Center/Tower, 111 Monument Circle, Suite 3700, Indianapolis, IN, 46204-5137, US

(21) Appl. No.: 10/269,451

(22) Filed: Oct. 14, 2002

(51) Int. Cl. B67D 5/06

(52) U.S. Cl. 222/185.1

(57) ABSTRACT

A system is provided for storing, transporting, and dispensing powder-like materials, the system (in various embodiments) being well adapted for automated and/or mechanical transport and reuse, reinforced pockets for lift forks, balls and caps adapted for stacking, and a transport cart for local movement. A rigid frame supports a container capable of dispensing the material in a controlled manner, the frame preferably having reinforced structures for accepting lift forks. An optional cart may be used to facilitate movement of the system between points of bulk transport, use, cleaning, and refilling, for example.

### BACKGROUND

The present invention relates to systems and apparatus for storing, transporting, or dispensing materials (e.g., powdered, granular, or pulverulent materials) in bulk.

Present bulk material storage methods and apparatus suffer from limitations in flexibility and ease of use, reusability, and ease of transport. For example, some systems require individuals to lift heavy bags of material and mount the bags onto a frame for use. Other systems are constructed in a form that makes mechanized or automated transport difficult.

There is thus a need for further contributions and improvements to bulk material storage, transport, and dispensing technology.

### SUMMARY

It is an object of the present invention to provide an improved system and method for storing, transporting, and dispensing bulk materials. Another object is to provide such a system with characteristics that facilitate mechanized or automated transport. Still another object is to provide such a system adapted to be cleaned and reused easily.

These objects and others are achieved by various forms of the present invention. One form of the present invention comprises a tank including a body portion and a hopper portion. The tank is supported by a rigid frame with flanges placed and formed so as to allow lifting of the frame and tank by mechanized or automated techniques. In some embodiments, these flanges are placed at a height below the center of gravity for the system when the bin is full.

Other embodiments include rigid sidewalls for the bin and/or hopper. In yet others, the frame defines a region of space completely enclosing the bin and/or hopper. In still others, a ball valve is placed in fluid communication with the bottom discharge opening of the hopper.

### BRIEF DESCRIPTION OF THE DRAWINGS

FIG. 1 is a perspective view of the material holding and dispensing portion of a system according to the present invention.

FIG. 2 is a perspective view of a frame adapted to support the assembly in FIG. 1.

FIG. 3 is a perspective view of a cart adapted to support the frame in FIG. 2.

### DESCRIPTION OF THE ILLUSTRATED EMBODIMENTS

For the purpose of promoting an understanding of the principles of the present invention, reference will now be made to the embodiment illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

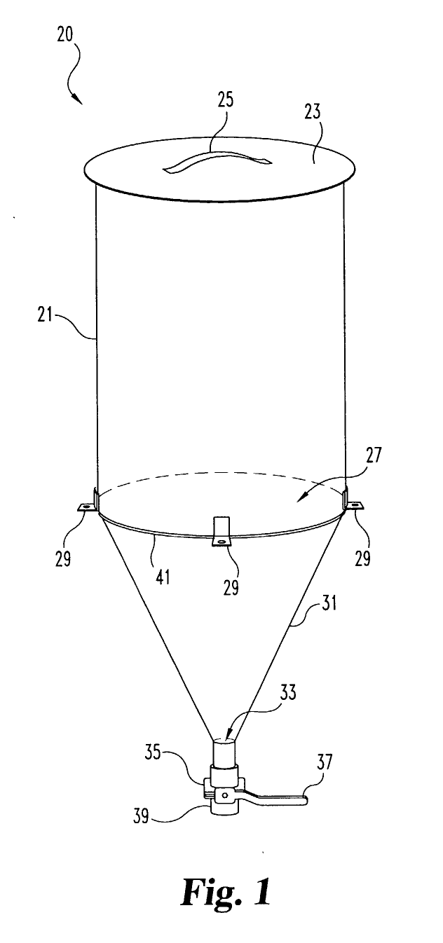

Generally, the material holding, transporting, and dispensing system illustrated in FIGS. 1-3 provide an improved, reusable powdered material storage, transport, and dispensing system that facilitates transport by mechanical and/or automated means.

FIG. 1 shows the material holding and dispensing portion 20 of the illustrated embodiment of the present invention. Bin 21 is generally cylindrical in shape and made of 16-gauge stainless steel. Bin 21 has a removable lid 23 with a handle 25, and has a bottom opening 27. Angle brackets 29 are affixed to the outer surface of bin 21 at or near its bottom in an evenly spaced fashion.

Hopper portion 31 is frustoconical in shape and inverted in orientation to accept material flowing from bin 21 through bottom opening 27. Hopper 31 guides material to its own bottom opening 33. In normal operation, material passes through bottom opening 33 to ball valve 35, which a user opens and closes by operating handle 37.

In this preferred embodiment, bin 21 is 24 inches in diameter, while bottom opening 33, ball valve 35, and tail pipe 39 are three inches in diameter. These exemplary specifications are suitable for holding and dispensing approximately 150 pounds of powder, but could be easily changed to accommodate other materials, capacities, and design criteria.

In this embodiment, container 20 is constructed of multiple, independently fabricated pieces, including lid 23, bin 21, hopper 31, valve 35, and tail piece 39. Lid 23 may rest on bin 21 by gravity, be latched to bin 21, use a threaded connection to bin 21, or employ another interface means as would occur to one skilled in the art. Bin 21 is welded at seam 41 to hopper 31, while valve 35 uses a threaded fittings to both hopper 31 and tail piece 39. Such welded and threaded interfaces provide useful properties, including a good seal (to avoid leakage) and strength to support the load of a full container. Other means may be used for connecting the components as would occur to one skilled in the art, and the apparatus may be made of more or fewer pieces composed, constructed, and assembled as would occur to one skilled in the art.

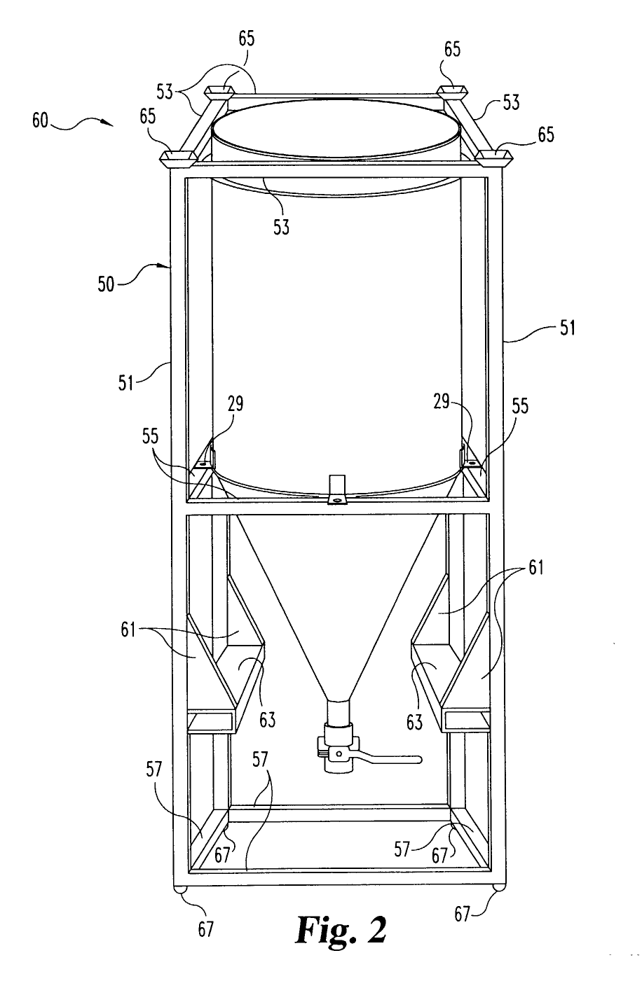

Turning to FIG. 2 with continuing reference to FIG. 1, we discuss frame 50 and its role in system 60. In this embodiment, frame 50 is a rigidly connected network comprising four vertical members 51, four horizontal top members (connecting the top ends of vertical members 51 to form a square), four horizontal center members 55 (also forming a square and connecting vertical members 51 at points separated from top members 53), and four horizontal bottom members 57 (forming a square connecting the lower end points of vertical members 51). Support members 55 are positioned to bear the weight of container 20 and its contents through brackets 29, which are removably attached to support members 55 using screws, bolts, or the like. In one embodiment, brackets 29 are, for example, three-inch by three-inch by one-quarter inch angle iron mounting clips, though other sizes and materials might be used as would occur to one skilled in the art.

A foot 67 is positioned at the bottom end of each vertical member 71 and is made, for example, of steel ball stock. A cap 65 at the top end of each vertical member 71 is adapted to receive a corresponding foot 67 so that frames 50 can be stacked securely.

Gussets 61 are affixed to vertical members 51 and lift pockets 63, which provide a surface to meet the forks of a mechanical or automatic lifting device such as a forklift. Using such lifting device, the system 60 can be carried intact from one location to another from either the front or back (relative to the perspective shown in FIG. 2).

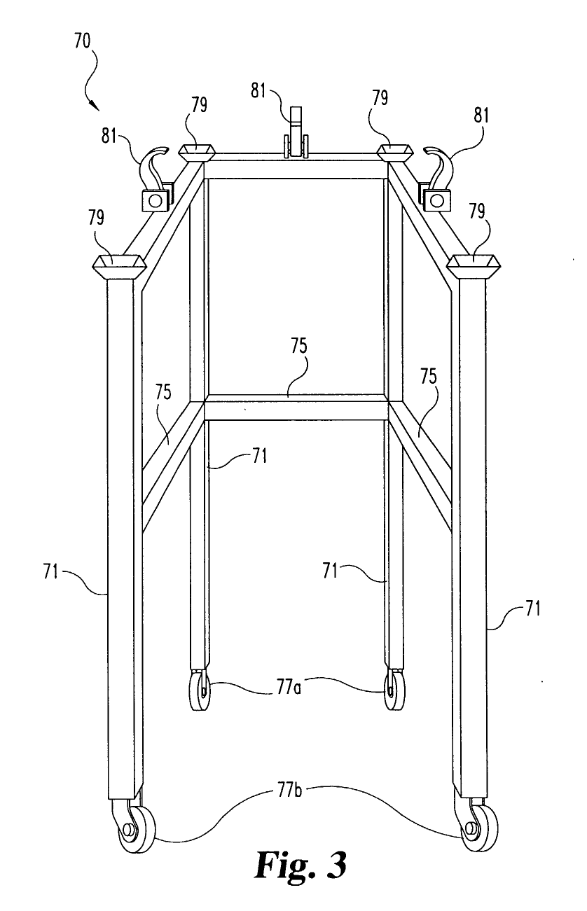

Alternatively, with reference to FIG. 3 and continuing reference to FIG. 2, a cart 70 having wheels 77a and 77b may be used to move system 60. Vertical members 71 are connected on three sides by top horizontal members 73 and middle horizontal members 75. Vertical members 71 have casters or other wheel components 77a and 77b at the bottom and caps 79 at the top (for receiving feet 67 of frame 50). In the present example, wheels 77a are fixed in orientation, while wheels 77b rotate freely about an axis approximately coincident with the corresponding vertical member 71.

Using cart 70, frame 50 can be moved into place for dispensing its contents, then easily moved away for transportation to a cleaning station, refilling station, and/or mass transport depot. Vertical members 71 and horizontal members 73 and 75 are preferably made of 1.5 inch by 1.5 inch square tubing of galvanized steel, though other sizes and materials might be used as would occur to one skilled in the art. Clamps 81 are affixed to horizontal members 73 and removably attach the bottom members 57 of frame 50 to the cart 70.

In the embodiment illustrated above, bin 21 is contained within the region of space defined by frame 50. In some environments this arrangement advantageously protects the integrity of bin 21 and hopper 31. In some alternative embodiments and environments, however, this characteristic is unnecessary, and bin 21 might be modified to extend outside the planes defined by the sides of the frame 50. Bin 21 in these alternative embodiments could have greater capacity while maintaining some of the other advantages provide by the present invention.

In still other embodiments, another type of valve may be substituted for ball valve 35, or ball valve 35 may be omitted entirely in favor of some other material control means as would occur to one skilled in the art. Furthermore, the interior of bin 21 may incorporate means known in the art to avoid common powder-handling problems such as arching, bridging, and “rat-holing” as those solutions may be understood in the art.

While the invention has been illustrated and described in detail in the drawings and foregoing description, the same is to be considered as illustrative and not restrictive in character, it being understood that only the preferred embodiments have been shown and described and that all changes and modifications that would occur to one skilled in the relevant art are desired to be protected.

What is claimed is:

1. A system, comprising:
a bin having a first bottom discharge opening;
a hopper, fixedly attached to said bin for receiving the contents of said bin through the first bottom discharge opening, and having a second bottom discharge opening;
a rigid frame having a vertical extent above and below said bin and said hopper; and
one or more flanges attached to said frame, wherein said one or more flanges are adapted to bear the weight of said bin, said hopper, and any contents thereof, for lifting and moving of the same by an external lifting apparatus.

2. The system of claim 1, wherein said bin has rigid side walls.

3. The system of claim 1, wherein said hopper has rigid side walls.

4. The system of claim 1, wherein said frame defines a region completely enclosing said bin.

5. The system of claim 4, wherein the region further encloses said hopper.

6. The system of claim 1, further comprising a ball valve in fluid communication with the second bottom discharge opening.

7. The system of claim 1, wherein said flanges are below the center of gravity of the system both when said bin is full and when said bin is empty.
